(19) United States
(12) Patent Application Publication
(10) Pub. No.: US 2024/0393991 A1
(43) Pub. Date: Nov. 28, 2024

(54) INFORMATION PROCESSING APPARATUS, DISPLAY METHOD, AND RECORDING MEDIUM HAVING APPLICATION RECORDED THEREON

(71) Applicant: SHARP KABUSHIKI KAISHA, Sakai City (JP)

(72) Inventor: Kazunori HASEGAWA, Sakai City (JP)

(21) Appl. No.: 18/608,443

(22) Filed: Mar. 18, 2024

(30) Foreign Application Priority Data
May 22, 2023 (JP) 2023-084028

(51) Int. Cl. G06F 3/12

(52) U.S. Cl. CPC G06F 3/1228; G06F 3/1205

(57) ABSTRACT

An information processing apparatus including a storage that stores an application capable of supporting print settings corresponding to a device in cooperation with a printer driver, a display that displays a user interface screen on the basis of the application, and a controller that determines the printer driver associated with the application at activation of the application, in which the controller determines display contents of the user interface screen in accordance with the printer driver associated with the application.

### BACKGROUND OF THE INVENTION

### Field of the Invention

The present disclosure relates to an information processing apparatus and the like.

### Description of the Background Art

A printer driver supplied by a vendor that provides a printing apparatus is configured to maximize the performance of the printing apparatus. However, the printer driver supplied by the vendor needs to be individually introduced by a user who uses the printing apparatus. Therefore, for a user who has difficulty in obtaining a printer driver because a network environment or the like is not prepared, for example, it is difficult to introduce a printer driver supplied by a vendor.

On the other hand, though a standard printer driver (hereinafter, simply referred to as a printer driver) incorporated in an operating system (OS) in advance does not need to be individually introduced by a user who uses a printing apparatus, available functions are limited to standard functions in order to cope with various types of printing apparatuses.

In view of such circumstances, in recent years, efforts have been made to fully utilize the capabilities of a printing apparatus by introducing a print support application (PSA) that supports printing using a printer driver.

The present disclosure has an object to provide an information processing apparatus and the like capable of displaying an appropriate user interface screen in accordance with a printer driver associated with a PSA in print processing using the PSA.

### SUMMARY OF THE INVENTION

In order to solve the aforementioned problem, an information processing apparatus according to the present disclosure includes a storage which stores an application capable of supporting a print setting corresponding to a device in cooperation with a printer driver, a display which displays a user interface screen on the basis of the application, and a controller which determines the printer driver associated with the application, characterized in that the controller determines display contents of the user interface screen in accordance with the printer driver associated with the application.

Moreover, a display method according to the present disclosure is characterized by storing an application capable of supporting a print setting corresponding to a device in cooperation with a printer driver, displaying a user interface screen on the basis of the application, determining the printer driver associated with the application, and determining display contents of the user interface screen in accordance with the printer driver associated with the application.

Further, an application according to the present disclosure is an application which can support a print setting corresponding to a device in cooperation with a printer driver, characterized by displaying a user interface screen and determining display contents of the user interface screen in accordance with the associated printer driver, in which the application is recorded in a non-transitory computer-readable recording medium.

According to the present disclosure, it is possible to provide an information processing apparatus and the like capable of displaying an appropriate user interface screen in accordance with a printer driver associated with a PSA in print processing using the PSA.

### BRIEF DESCRIPTION OF THE DRAWINGS

FIG. 1 is a diagram for explaining a connection form of an information processing apparatus according to a First Embodiment.

FIG. 2 is a diagram for explaining a functional configuration of the information processing apparatus according to the First Embodiment.

FIG. 3A and FIG. 3B are diagrams for explaining device information.

FIG. 4 is a diagram for explaining a functional configuration of the printing apparatus according to the First Embodiment.

FIG. 5 is a flowchart for explaining a flow of processing according to the First Embodiment.

FIG. 6 is a diagram for explaining an operation example according to the First Embodiment.

FIG. 7 is a diagram for explaining an operation example according to the First Embodiment.

FIG. 8 is a diagram for explaining an operation example according to the First Embodiment.

FIG. 9 is a diagram for explaining an operation example according to the First Embodiment.

FIG. 10 is a diagram for explaining an operation example according to the First Embodiment.

FIG. 11 is a diagram for explaining an operation example according to the First Embodiment.

FIG. 12 is a diagram for explaining an operation example according to the First Embodiment.

FIG. 13A and FIG. 13B are diagrams for explaining an operation example according to a Second Embodiment.

FIG. 14 is a flowchart for explaining a flow of processing according to a Third Embodiment.

FIG. 15 is a flowchart for explaining a flow of processing according to a Fourth Embodiment.

### DESCRIPTION OF THE PREFERRED EMBODIMENTS

Hereinafter, embodiments of the present disclosure will be explained with reference to the drawings. Note that the following embodiments are examples for explaining the present disclosure, and technical contents of the explanation described in the scope of claims are not limited to the following description.

When a printing apparatus such as a multifunction peripheral is controlled to cause a print job to be processed, an information processing apparatus generates a print job via a dedicated printer driver installed in an operating system (OS) or a printer driver provided as a standard function of the OS. In general, a dedicated printer driver to be used by being installed in the OS is provided for each printing apparatus by a vendor of the printing apparatus, and is configured to be able to sufficiently exert capability of the printing apparatus.

On the other hand, the printer driver only supports functions common to the respective printing apparatuses in order to provide versatility that enables printing by many (many types of) printing apparatuses in many cases. In recent years, even in the case of processing a print job using a printer driver, there has been an increasing demand for the print results similar to those in the case of using a dedicated printer driver. Further, in order to improve stability and security of the OS, approaches have been made by vendors that provide the OS to expand the functions of the printer driver.

As an aspect of the above approach, a PSA that supports processing of a print job by a printer driver is known. In general, the PSA is supplied as an application by a vendor or the like that provides an OS or a printing apparatus. The PSA is configured to cooperate with the associated printer driver so that the functions of the printing apparatus can be sufficiently exerted on the basis of the obtained capability information of the printing apparatus. For example, the PSA can change Page Description Language (PDL) and add a Print Job Language (PJL) command to a print job on the basis of the printer driver.

The print function that can be supported by the PSA varies depending on the associated printer driver. For example, a manuscript size, a paper size, and a paper type supported by the PSA differ between an Internet Printing Protocol (IPP) class driver applied when print is performed wirelessly from a mobile terminal such as a smart-phone or tablet using a print service such as Airprint (Registered Trademark) or Mopria (Registered Trademark), and a universal print class driver applied when print is performed via a cloud service by a device compatible with universal print. In order for a user to perform print setting without confusion or stress, appropriate display control of a user interface screen in accordance with an associated printer driver has been in demand.

An information processing apparatus capable of displaying an appropriate user interface screen in accordance with a printer driver associated with a PSA in print processing using the PSA is realized by the following embodiments.

### 1 First Embodiment

### 1. 1 Overall Configuration

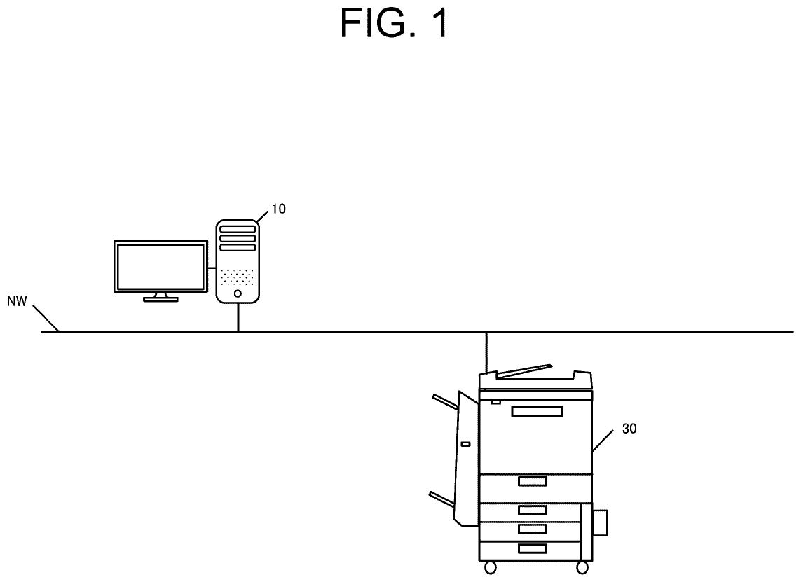

FIG. 1 is a diagram for explaining an example of a connection form between a terminal device 10 as an information processing apparatus according to a First Embodiment and a multifunction peripheral 30 as a printing apparatus.

The terminal device 10 according to the First Embodiment can be configured as a computer capable of operation based on a specific OS. The terminal device 10 can generate a print job on the basis of a printer driver incorporated in the OS in advance and transmit it to the multifunction peripheral 30 via a network NW. The multifunction peripheral 30 is a printing apparatus capable of realizing jobs such as printing, copying, faxing, image transmission and the like in a single housing. The multifunction peripheral 30 can form an image on a recording sheet on the basis of the print job received from the terminal device 10.

Incidentally, FIG. 1 shows a form in which the multifunction peripheral 30 is connected to the network NW, but the multifunction peripheral 30 may be connected to another network NW (not shown) connected to the network NW, and a plurality of multifunction peripherals 30 may be connected to the network NW. Further, the multifunction peripheral 30 may be a printing apparatus specialized for a specific function such as a printer or a facsimile apparatus.

### 1. 2 Functional Configuration

### 1. 2. 1 Terminal Device 10

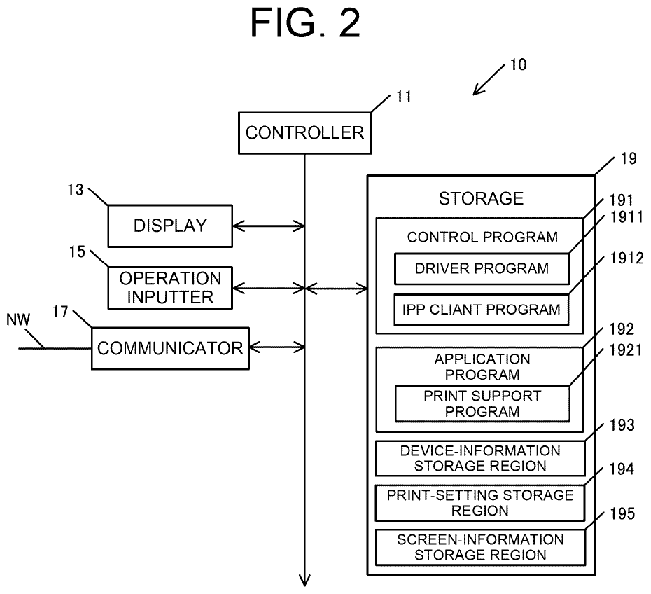

A functional configuration of the terminal device 10 will be explained. FIG. 2 is a diagram for explaining a functional configuration of the terminal device 10. The terminal device 10 includes a controller 11, a display 13, an operation inputter 15, a communicator 17, and a storage 19.

The controller 11 controls the entire terminal device 10. The controller 11 is configured by, for example, one or more arithmetic devices (such as Central Processing Units (CPU) and the like). The controller 11 realizes its functions by reading and executing various programs stored in the storage 19.

The display 13 is a display device that displays various kinds of information to a user or the like. The display 13 can be configured by, for example, a Liquid Crystal Display (LCD), an organic Electro-luminescence (EL) display or the like.

The operation inputter 15 is an input device that accepts an input of information from a user or the like. As the operation inputter 15, an inputter such as a keyboard, a mouse, a touch panel or the like can be used, for example.

The communicator 17 includes, for example, either one or both of a wired/wireless interface for performing communication with another apparatus (the multifunction peripheral 30 or the like) via a Local Area Network (LAN), a Wide Area Network (WAN), the Internet, a telephone line or the like. Note that, the communicator 17 may include an interface related to (short-range) wireless communication art such as Bluetooth (Registered Trademark), Near Field Communication (NFC), Wi-Fi (Registered Trademark), ZigBee (Registered Trademark), IrDA, wireless USB and the like, for example.

The storage 19 is a storage device that stores various programs required for the operation of the terminal device 10 and various types of data. The storage 19 can be constituted by storage devices such as a Random Access Memory (RAM), a Hard Disk Drive (HDD), a Solid State Drive (SSD), a Read Only Memory (ROM) and the like, for example.

In the First Embodiment, the storage 19 stores a control program 191 and an application program 192 and ensures a device-information storage region 193, a print-setting storage region 194, and a screen-information storage region 195.

The application program 192 is stored in the storage 19 which is a non-transitory computer-readable recording medium such as a ROM, for example.

The control program 191 is a program read by the controller 11 when the terminal device 10 is controlled in an integrated manner. The controller 11 that has read the control program 191 functions as an OS and performs control of driving of hardware such as the display 13, the operation inputter 15, the communicator 17 and the like, activation and termination of an application driven on the OS, file management and the like. Further, when a (new) connection with the multifunction peripheral 30 or the like as a printing apparatus is detected on the basis of a plug-and-play function or the like, for example, the controller 11 that has read the control program 191 executes processing (acquisition of device information and the like, for example) required for recognizing and using the multifunction peripheral 30.

The control program 191 includes a driver program 1911 and an IPP client program 1912. The driver program 1911 is a (standard) printer driver that operates on the OS. In the present disclosure, explanation will be made by assuming that two types of printer drivers, that is, an IPP class driver and a universal print class driver, are stored as the driver program 1911 as printer drivers that can be associated with the PSA. The IPP client program 1912 is a program read by the controller 11 when a print job is exchanged with the multifunction peripheral 30 on the basis of the IPP. The controller 11 that has read the IPP client program 1912 searches the multifunction peripheral 30 and transmits an obtainment request for capability information or a generated print job to the multifunction peripheral 30 on the basis of IPP.

The application program 192 is a program read by the controller 11 upon receipt of an activation instruction from the user. The controller 11 that has read the application program 192 provides a specific function corresponding to the purpose of the user, such as document creation, graphic drawing, Internet browsing and the like. The application program 192 can be acquired by installation using a recording medium such as a CD or a DVD, downloading from a service providing server (not shown), or the like.

The application program 192 includes a print support program 1921. The print support program 1921 is a program that functions as PSA by being read by the controller 11 and improves and enhances a print result in cooperation with the associated printer driver. When the controller 11 is activated as PSA, the controller 11 refers to the Device Containers managed by the OS as device information to determine which of the IPP class driver and the universal print class driver, the printer driver associated with the PSA is. Then, in accordance with the printer driver associated with the PSA, the controller 11 determines the display contents of a user interface screen for accepting print settings, generates a screen and displays it on the display 13. The controller 11 stores the print setting accepted via the user interface screen in the storage 19. Then, when an input of a print execution instruction is accepted, the controller 11 generates a print job in which the stored print setting is reflected, and transmits the print job to the target multifunction peripheral 30.

The device-information storage region 193 is a storage region that stores device information (Device Containers) managed by the OS. The Device Containers is obtained by grouping, on a container basis, device information required for recognizing and using a printing apparatus (multifunction peripheral 30) connected to the terminal devices 10. The Device Containers according to the present disclosure contains at least System.Devices. CompatibleIds and System.Devices.ModelName.

The System.Devices.CompatibleIds represents a set of CompatibleId (compatibility identifiers) of the multifunction peripheral 30. The compatibility identifier is an identifier used when the OS determines the driver program to be installed on the basis of the compatibility of the device. In general, the compatibility identifier is set by a vendor of the multifunction peripheral, and can be constituted by, for example, a character string representing an identifier such as a vendor ID, a product ID, or a serial number. The System. Devices.CompatibleIds managed by the OS is a set of compatibility identifiers obtained from the devices, and the value of the compatibility identifier varies depending on whether it is the IPP class driver or the universal print class driver. Therefore, the controller 11 can determine whether the printer driver associated with the PSA is the IPP class driver or the universal print class driver by obtaining and referring to the compatibility identifier (value) from the System.Devices. CompatibleIds.

System. Devices.ModelName is a model name of Device Containers to be referred to when the controller 11 could not obtain a compatibility identifier from the System.Devices. CompatibleIds. The Device Containers has a driver name corresponding to each of the IPP class driver and the universal print class driver as a model name. By obtaining the driver name from the System. Devices.ModelName, the controller 11 can determine whether the printer driver associated with the PSA is the IPP class driver or the universal print class driver.

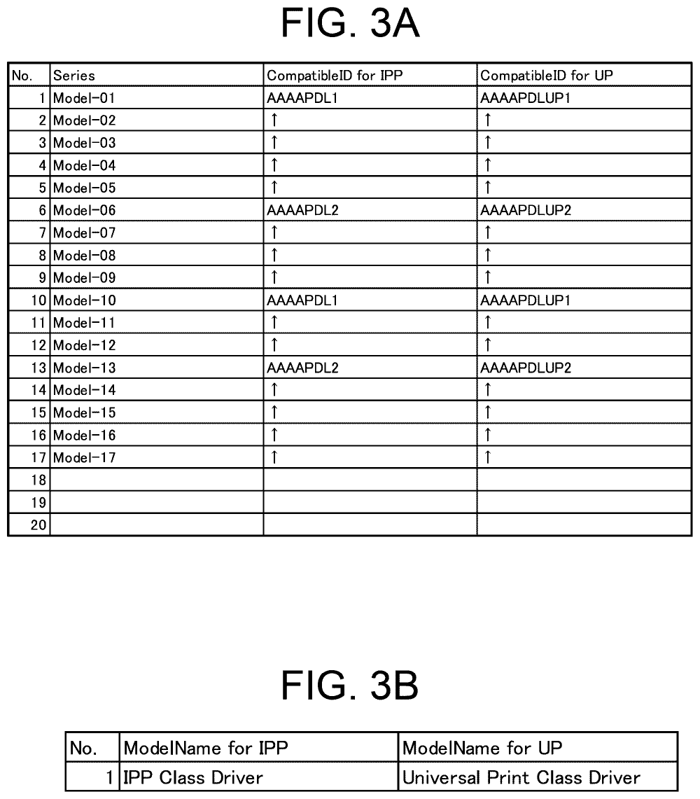

FIG. 3A is a diagram for explaining an example of assigning compatibility identifiers to multifunction peripherals represented by Series “Model-01 to Model-17”. In FIG. 3A, an identifier of “AAAAPDL1” as the compatibility identifier (CompatibleID for IPP) for the IPP class driver or an identifier of “AAAAPDLUP1” as the compatibility identifier (CompatibleID for UP) for the universal print class driver is given to Series “Model-01 to Model-05” is illustrated, for example. Similarly, for example, Series “Model-13 to Model-17” are examples of a case where either one of identifiers of “AAAAPDL2” as the compatibility identifier (CompatibleID for IPP) for the IPP class driver and “AAAAPDLUP2” as the compatibility identifier (CompatibleID for UP) for the universal print class driver is given. For example, when the compatibility identifier assigned to “Model-01 to Model-05” is “AAAAPDL1”, the controller 11 determines that the printer driver associated with the PSA is the IPP class driver. On the other hand, if the given compatibility identifier is “AAAAPDLUP1”, the controller 11 determines that the printer driver associated with the PSA is the universal print class driver.

FIG. 3B illustrates an example of a case in which either one of the driver name “IPP Class Driver” corresponding to the IPP class driver and the driver name “Universal Print Class Driver” corresponding to the universal print class driver is given as the model name of Device Containers. When the compatibility identifier could not be obtained from the System.Devices. CompatibleIds exemplified in FIG. 3A, the controller 11 can determine that the printer driver associated with the PSA is either one of the IPP class driver and the universal print class driver by referring to the driver name given as the model name of the Device Containers.

Referring back to FIG. 2, the print-setting storage region 194 is a storage region that stores print settings accepted via a user interface screen for accepting print settings.

The screen-information storage region 195 is a storage region that stores screen information (image/screen contents) of a setting screen for accepting selection of the multifunction peripheral 30 to cause the print processing to be executed and a user interface screen for accepting print settings corresponding to the printer driver.

### 1. 2. 2 Multifunction Peripheral 30 and the Like

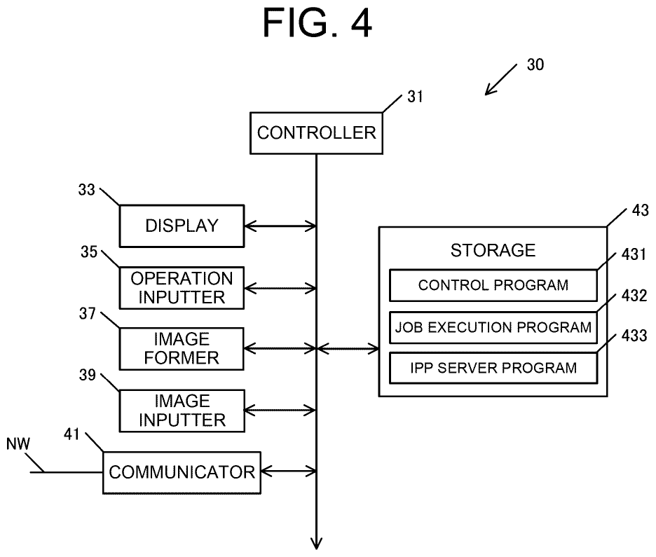

Subsequently, a functional configuration of the multifunction peripheral 30 will be described. FIG. 4 is a functional block diagram of the multifunction peripheral 30. The multifunction peripheral 30 includes a controller 31, a display 33, an operation inputter 35, an image former 37, an image inputter 39, a communicator 41, and a storage 43.

The controller 31 controls the entire multifunction peripheral 30. The controller 31 is constituted by one or more arithmetic devices (such as CPUs), for example. The controller 31 realizes its functions by reading and executing various programs stored in the storage 43.

The display 33 is a display device that displays various kinds of information to a user or the like. The display 33 may be constituted by an LCD, an organic EL display or the like, for example.

The operation inputter 35 is an input device that accepts input of information by a user or the like. The operation inputter 35 can be constituted by various input devices including operation keys such as hard keys and software key, buttons or the like, for example. Note that the operation inputter 35 may be configured as a touch panel that allows an input via the display 33. In this case, as an input method of the touch panel, a general method such as a resistive film method, an infrared method, an electromagnetic induction method, or a capacitance method, for example, can be adopted.

The image former 37 feeds a sheet from a feed tray, not shown, forms an image based on document data included in a print job and then, discharges the sheet to a sheet discharger, not shown. The image former 37 may be configured by a laser printer or the like employing an electrophotographic method, for example. In this case, the image former 37 forms images using toners supplied from toner cartridges, not shown, corresponding to respective toner colors (cyan, magenta, yellow, and black, for example).

The image inputter 39 generates document data by scanning a manuscript The image inputter 39 includes an image sensor such as a Charge Coupled device (CCD), a Contact Image Sensor (CIS) or the like, and can be configured as a scanner device having an Automatic document feeder (ADF), a flatbed on which the manuscript is placed and read, and the like. The configuration of the image inputter 39 is not particularly limited as long as it can generate image data by reading a reflected light image from a manuscript image with the image sensor. Note that the image inputter 39 can also be configured as an interface capable of obtaining the document data that is stored in a portable storage medium such as a Universal Serial Bus (USB) memory or the like and the print job transmitted from the terminal device 10, for example.

The communicator 41 includes, for example, either one or both of wired/wireless interfaces for performing communication with another device (the terminal device 10) via a network NW such as a LAN, a WAN, the Internet, a telephone line, or a fax line. Further, the communicator 41 may include an interface related to (short-range) wireless communication art such as Bluetooth (Registered Trademark), Near field communication (NFC), Wi-Fi (Registered Trademark), ZigBee (Registered Trademark), Irda, wireless USB and the like, for example.

The storage 43 stores various programs and various data required for the operation of the multifunction peripheral 30. The storage 43 may be constituted by a storage device such as a RAM, an HDD, an SSD, a ROM, and the like, for example.

In the First Embodiment, the storage 43 stores a control program 431, a job execution program 432, and an IPP server program 433.

The control program 431 is a program read by the controller 31 when the multifunction peripheral 30 is integrally controlled. The controller 31 that has read the control program 431 controls the driving of the display 33, the operation inputter 35, the image former 37, the image inputter 39, the communicator 41, and the like.

The job execution program 432 is a program read by the controller 31 when a job such as printing, copying, faxing, image transmission or the like is executed.

The IPP server program 433 is a program read by the controller 31 when a print job is exchanged with the terminal device 10 as a client device on the basis of the IPP. A response to the search by the terminal device 10, a response to the obtainment request for the capability information, or the print job transmitted from the terminal device 10 is obtained.

### 1. 3 Flow of Processing

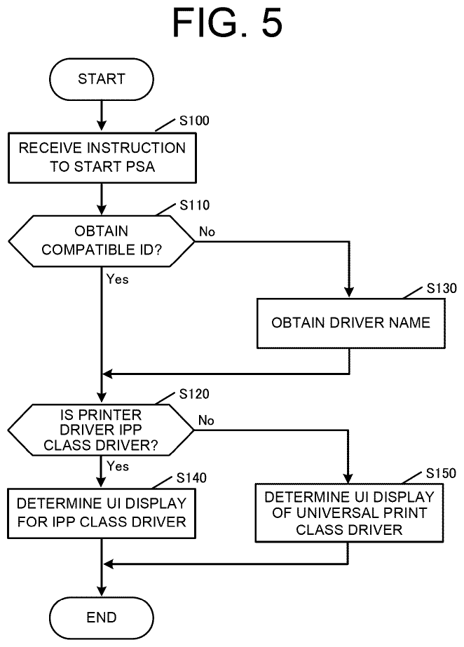

Subsequently, a flow of processing according to the First Embodiment will be explained with reference to a flowchart in FIG. 5. FIG. 5 is a flowchart for explaining processing executed by the controller 11 of the terminal device 10 when the PSA is activated as a flow of the processing according to the First Embodiment. The controller 11 of the terminal device 10 executes the processing illustrated in FIG. 5 particularly by reading the print support program 1921.

When a PSA icon included in a start menu, not shown, is selected or when a printer driver is set up, for example, the controller 11 accepts an input of an instruction to activate the PSA (Step S100).

The controller 11 activates the PSA by reading the print support program 1921. When the PSA is activated, the controller 11 determines whether or not a compatibility identifier could be obtained from the System. Devices. CompatibleIDs of Device Containers exemplified in FIG. 3 (Step S110). In a case where it is determined that the compatibility identifier could be obtained, the controller 11 determines whether or not the printer driver associated with the PSA is the IPP class driver (Step S110; Yes→Step S120). On the other hand, when it is determined that the compatibility identifier could not be obtained, the controller 11 obtains the driver name from the System.Devices ModelName of Device Containers (Step S110; No→Step S130).

In a case where it is determined that the printer driver associated with the PSA is the IPP class driver, the controller 11 determines the user interface screen to be displayed on the display 13 is the display contents for the IPP class driver, and ends the processing (Step S120; Yes→Step S140). On the other hand, in a case where it is determined that the printer driver associated with the PSA is the universal print class driver, the controller 11 determines that the user interface screen to be displayed on the display 13 is the display contents for the universal print class driver, and ends the processing (Step $120; No→Step S150).

### 1. 4 Operation Example

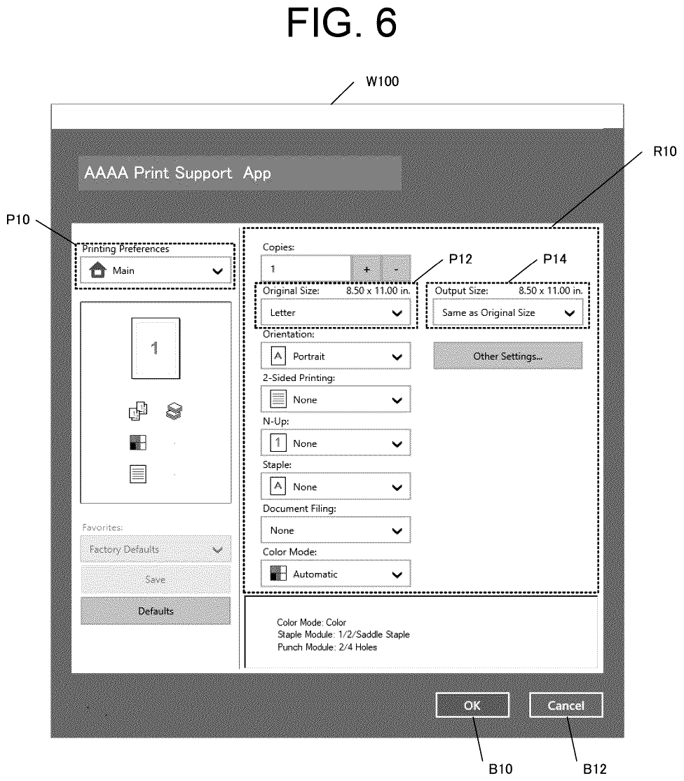

Subsequently, an operation example according to the First Embodiment will be explained. FIG. 6 is an example of a display configuration of a user interface screen W100 displayed in accordance with a printer driver associated with the PSA, when the PSA is activated. With reference to FIG. 6, an overview of constituent elements of the user interface screen W100 according to the First Embodiment will be explained.

The user interface screen W100 includes a print setting pull-down menu P10, a print setting region R10, an “OK” button B10, and a “cancel” button B12.

The print setting pull-down menu P10 is a pull-down menu for accepting an instruction to select or change print setting (item) to be displayed in the print setting region R10. FIG. 6 illustrates an example of a case where “Main” for displaying “Copies”, “Original Size”, “Output Size”, “Orientation”, and the like as main print setting items in the print setting region R10 was selected as a menu of the print setting pull-down menu P10.

The print setting region R10 is a region for displaying print setting items set in advance in accordance with a menu selected in the print setting pull-down menu P10. In the print setting region R10, a selection/change unit (for example, a pull-down menu P12, P14, or the like) that accepts an instruction to select or change a setting value for each print setting item, and an input unit that accepts an input of the number of copies “Copies” or the like are provided.

The “OK” button B10 is a button for accepting a confirmation instruction of the print setting in the print setting region R10. The “cancel” button B12 is a button for accepting an instruction to cancel the print setting in the print setting region R10.

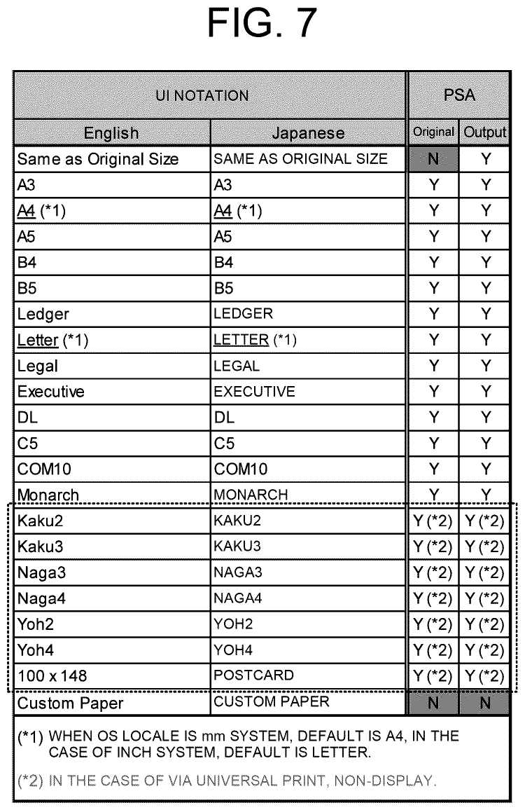

In the First Embodiment, the controller 11 generates and displays a user interface screen in which the selectable ranges of the manuscript size, the paper size, and the paper type are different between the case where the printer driver associated with the PSA is the IPP class driver and the case where the printer driver is the universal print class driver. FIG. 7 is a table showing manuscript sizes and paper sizes selectable on the user interface screen W100 in the case where the printer driver is the IPP class driver and in the case where the printer driver is the universal print class driver, respectively.

In a case where the printer driver associated with the PSA is the IPP class driver, the pull-down menu P12 “Original Size (manuscript size)” and the pull-down menu P14 “Output Size (sheet size)” in the print setting region R10 are displayed so that the user can select the manuscript size including the envelope/postcard (*2) indicated by the dotted-line frame in the drawing. Here, the “Original Size” (manuscript size) represents the size of a manuscript created by a document creation application. On the other hand, the “Output Size (sheet size)” represents the size of a sheet to be printed (output) by the printing apparatus.

On the other hand, when the printer driver associated with the PSA is the universal print class driver, the manuscript size of the envelope/postcard (*2) indicated by the dotted line frame in the drawing is not displayed in the pull-down menu P12 “Original Size” and the pull-down menu P14 “Output Size” of the print setting region R10.

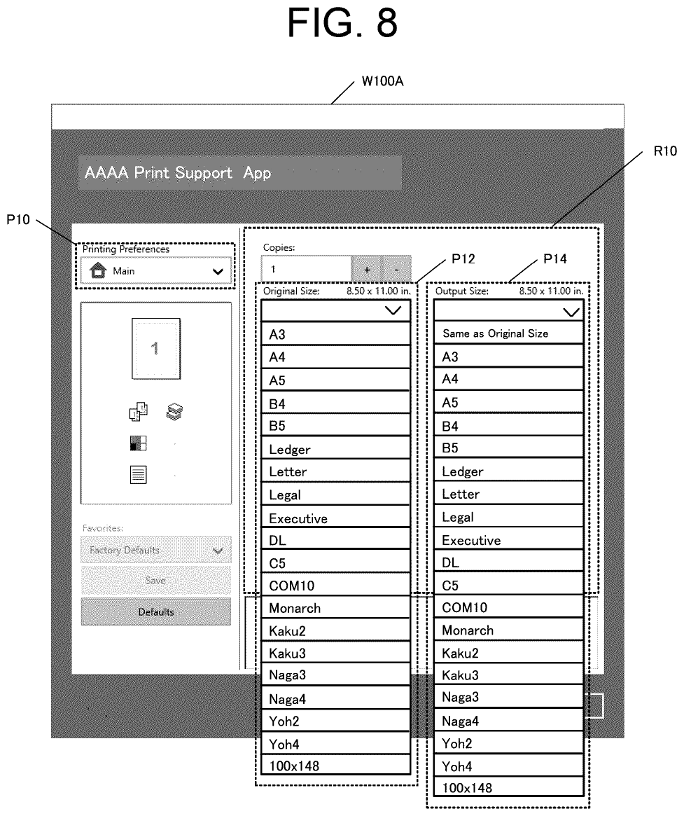

FIG. 8 is a diagram for explaining an example of a display configuration of the user interface screen W100A displayed by the controller 11 when it is determined that the printer driver associated with the PSA is the IPP class driver. FIG. 8 is an example illustrating that “A3” to “100×148 (postcard)” can be selected as the manuscript size in the pull-down menu P12 “Original Size” of the user interface screen W100A and “Same as Original Size” to “100×148 (postcard)” can be selected as the sheet size in the pull-down menu P14 “OutputSize”.

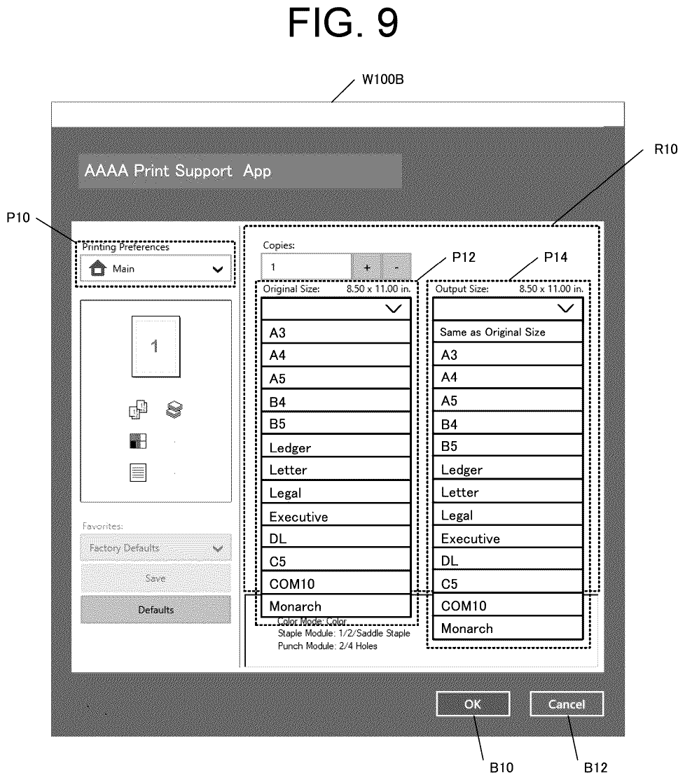

On the other hand, FIG. 9 is a diagram for explaining an example of a display configuration of the user interface screen W100B displayed by the controller 11 when it is determined that the printer driver associated with the PSA is the universal print class driver. FIG. 9 is an example illustrating that “A3” to “Monarch” can be selected as the manuscript size in the pull-down menu P12 “Original Size” of the user interface screen W100B, and “Same as Original Size” to “Monarch” can be selected as the sheet size in the pull-down menu P14 “Output Size”.

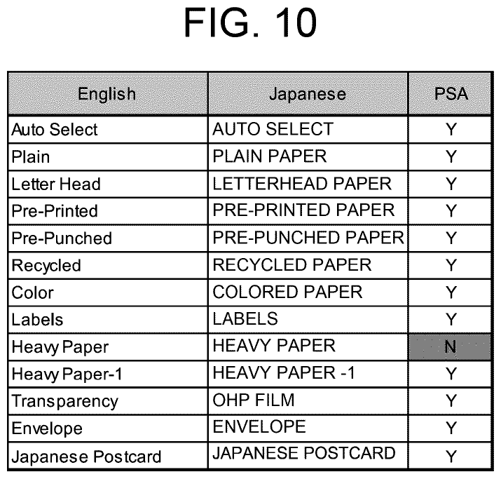

Subsequently, FIG. 10 is a diagram showing sheet types selectable on the user interface screen W100A when the printer driver is the IPP class driver. Note that if the printer driver is the universal print class driver, only plain paper is supported as the sheet type and thus, the sheet type exemplified in FIG. 10 cannot be selected.

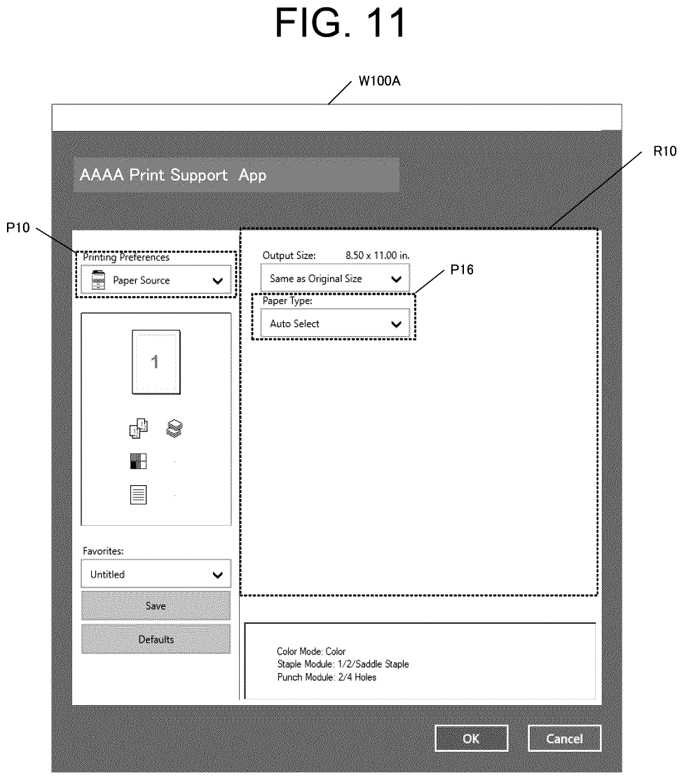

FIG. 11 is a diagram for explaining another example of a display configuration of the user interface screen W100A displayed by the controller 11 when it is determined that the printer driver associated with the PSA is the IPP class driver. FIG. 11 is an example of a case where “Paper Source” is selected as the menu of the print setting pull-down menu P10 so as to display “Output Size” and “Paper Type” as the print setting items in the print setting region R10. On the user interface screen W100A, a pull-down menu P16 of “Paper Type (sheet type)” is displayed so that the sheet type exemplified in FIG. 10 can be selected. Note that the sheet type represents the type (kind) of paper to be printed (output) by the printing apparatus.

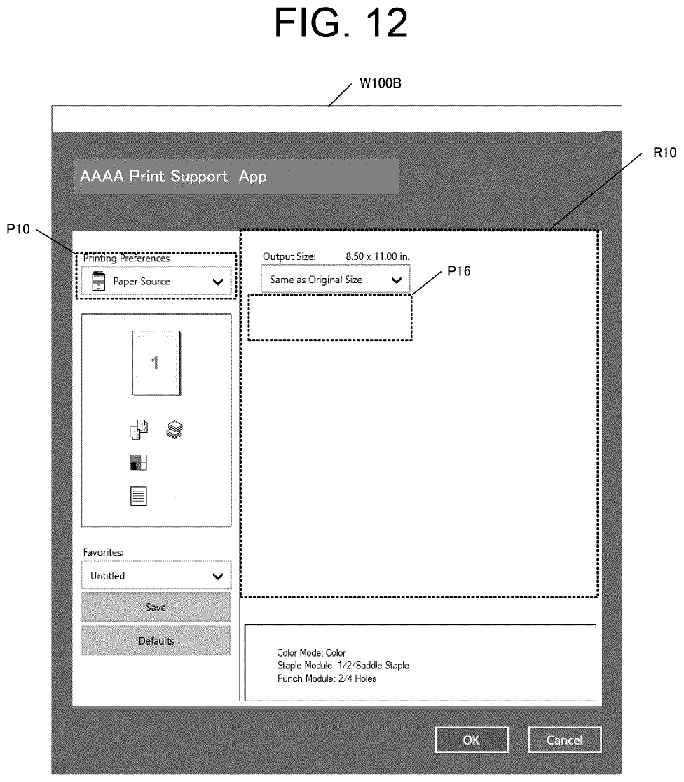

On the other hand, FIG. 12 is a diagram for explaining another example of a display configuration of the user interface screen W100B displayed by the controller 11 when it is determined that the printer driver associated with the PSA is the universal print class driver. FIG. 12 is an example of a case where “Paper Source” is selected as the menu of the print setting pull-down menu P10 so as to display “Output Size” as the print setting item in the print setting region R10. On the user interface screen W100B, the pull-down menu P16 of “Paper Type” related to the selection of the sheet type is not displayed.

As described above, according to the First Embodiment, when the PSA is activated, a printer driver associated with the PSA can be determined, and an appropriate user interface screen can be displayed in accordance with the printer driver associated with the PSA and thus, even if print settings supportable by the PSA vary depending on the printer driver, the user can make print settings without confusion or stress.

### 2. Second Embodiment

The Second Embodiment is a mode in which, in the configuration of the First Embodiment, at display of the user interface screen, it is clearly indicated which of the IPP class driver or the universal print class driver, the printer driver associated with the PSA is.

The overall configuration, the functional configurations of the terminal device and the multifunction peripheral, and the flow of processing according to the Second Embodiment can be the same as those of the First Embodiment and thus, explanation thereof will be omitted here.

### 2.1 Operation Examples

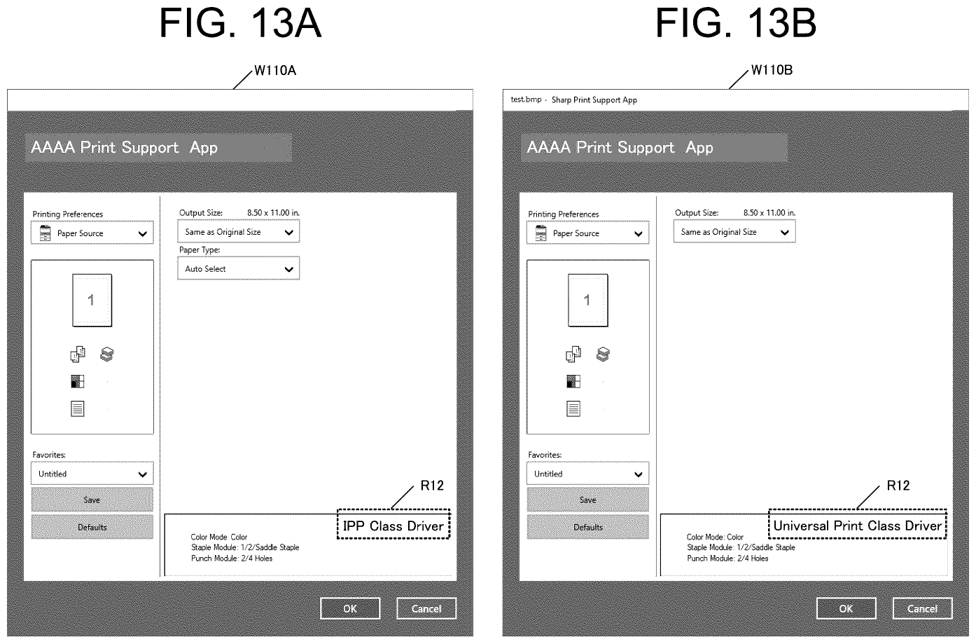

FIGS. 13A and 13B are diagrams illustrating examples of a display configuration of the user interface screen W110A (FIG. 13A) displayed when the controller 11 determines that the printer driver associated with the PSA is the IPP class driver and a user interface screen W110B (FIG. 13B) displayed when the controller 11 determines that the printer driver associated with the PSA is the universal print class driver. The user interface screen W110A illustrated in FIG. 13A and the user interface screen W110B illustrated in FIG. 13B are different from the user interface screens W100 (the user interface screen W100A (FIG. 11) and the user interface screen W100B (FIG. 12)) according to the First Embodiment in a point that each includes a printer-driver display region R12 that clearly indicates the printer driver associated with the PSA.

The user interface screen W110A shown in FIG. 13A is an example in which “IPP Class Driver” indicating that the printer driver associated with the PSA is the IPP class driver is displayed in the printer-driver display region R12. On the other hand, the user interface screen W110B shown in FIG. 13B is an example in which “Universal Print Class Driver” indicating that the printer driver associated with the PSA is the universal print class driver is displayed in the printer-driver display region R12.

As described above, according to the Second Embodiment, in addition to the effects of the First Embodiment, since the associated printer driver can be clearly indicated on the user interface screen displayed in accordance with the printer driver associated with the PSA, the user can perform the print setting while grasping whether the print setting is performed via the interface screen based on any one of the printer drivers.

### 3 Third Embodiment

In the First Embodiment or the Second Embodiment, such a configuration was explained that, when the PSA icon included in the start menu, not shown, is selected or when the printer driver is set up, an instruction to activate the PSA is accepted, and the display contents of the user interface screen are determined in accordance with the printer driver associated with the PSA. In a Third Embodiment, a mode in which the display contents of a user interface screen are determined in accordance with a printer driver associated with the PSA will be explained by using device selection as a trigger each time a print operation is started via an application which provides functions such as document creation, graphic drawing, and Internet browsing.

The overall configuration and the functional configurations of the terminal device and the multifunction peripheral according to the Third Embodiment can be the same as those of the First Embodiment and thus, explanation thereof will be omitted here.

### 3. 1 Flow of Processing

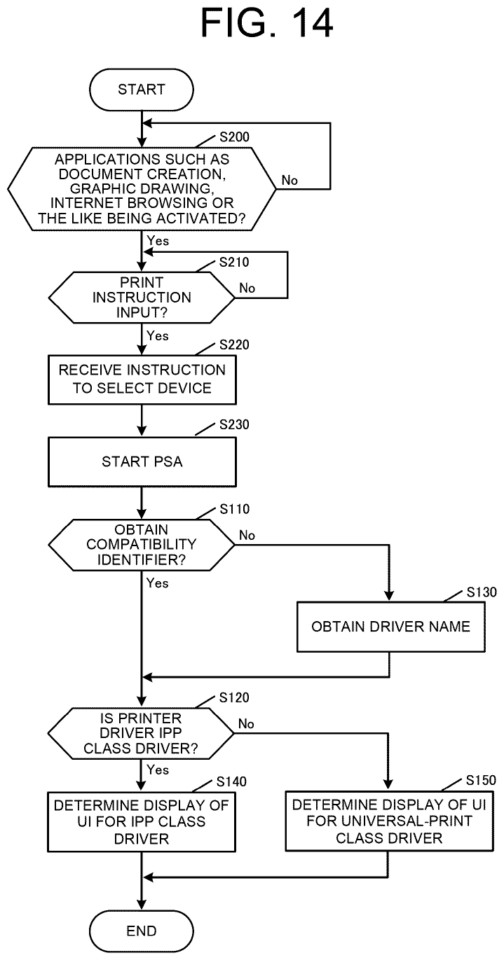

The flow of processing according to the Third Embodiment will be explained with reference to the flowchart of FIG. 14. Note that the processing which can be the same as the processing described in the flowchart of FIG. 5 of the First Embodiment are denoted by the same step numbers, and explanation thereof will be omitted. The controller 11 of the terminal device 10 executes the processing illustrated in FIG. 14 by reading the application program 192 and the print support program 1921.

First, the controller 11 determines whether or not an application such as document creation, graphic drawing, or Internet browsing is being activated (Step S200). In a case where the controller 11 determines that an application such as document creation, figure drawing, or Internet browsing is being activated, the controller 11 determines whether or not a print instruction was input via a print dialog, not shown, or the like (Step S200; Yes→Step S210). Note that, when the controller 11 determines that an application such as document creation, figure drawing, or Internet browsing is not being activated, the controller 11 waits until the application is activated (Step S200; No).

In a case where the controller 11 determines that the print instruction was input, the controller 11 accepts selection of the multifunction peripheral 30 to cause the print to be performed (Step S210; Yes→Step S220). Note that, in a case where the controller 11 determines that the print instruction has not been input, the controller 11 waits until the print instruction is input (Step S210; No).

When the controller 11 accepts the selection of the multifunction peripheral 30 to cause the print to be performed, the controller 11 activates the PSA with the selection as a trigger (Step S220→Step S230). Subsequently, the controller 11 executes processing at Step S110, which was explained in FIG. 5, and after.

As described above, according to the Third Embodiment, in addition to the effects of the First Embodiment, the display contents of the user interface screen can be determined in accordance with the printer driver associated with the PSA by using the selection of the printing apparatus as a trigger each time a printing operation is started via an application that provides functions such as document creation, graphic drawing, and Internet browsing and thus, the user can execute more flexible print settings in a case where an output destination of a print result is to be changed or the like in accordance with the application.

### 4 Fourth Embodiment

In the Fourth Embodiment, a mode to determine the display contents of the user interface screen on the basis of the analysis result of the print function of the device selected at the time of printing will be explained.

The overall configuration and the functional configurations of the terminal device and the multifunction peripheral according to the Fourth Embodiment can be the same as those of the First Embodiment and thus, explanation thereof will be omitted here.

### 4. 1 Flow of Processing

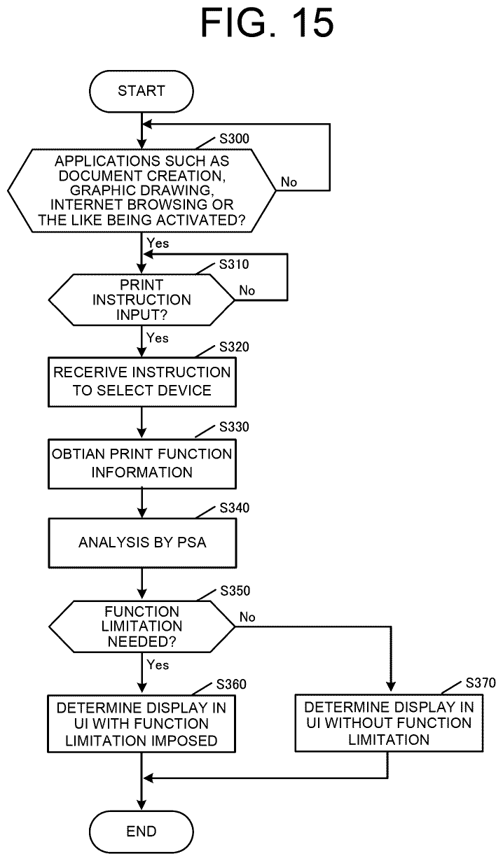

The flow of processing according to the Fourth Embodiment will be explained with reference to the flowchart of FIG. 15. The controller 11 of the terminal device 10 executes the processing illustrated in FIG. 15 by reading the application program 192 and the print support program 1921.

First, the controller 11 determines whether or not an application such as document creation, graphic drawing, or Internet browsing is being activated (Step S300). In a case where the controller 11 determines that an application such as document creation, figure drawing, or Internet browsing is being activated, the controller 11 determines whether or not a print instruction was input via a print dialog, not shown, or the like (Step S300; Yes→Step S310). Note that, when the controller 11 determines that an application such as document creation, figure drawing, or Internet browsing is not being activated, the controller 11 waits until the application is activated (Step S300; No).

In a case where the controller 11 determines that the printing instruction was input, the controller 11 accepts selection of the multifunction peripheral 30 to cause the print to be performed (Step S310; Yes→Step S320). Note that, in a case where the controller 11 determines that the print instruction was not input, the controller 11 waits until the print instruction is input (Step S310; No).

When the controller 11 accepts the selection of the multifunction peripheral 30 to cause the print to be performed, the controller 11 obtained, from the multifunction peripheral 30, information (print function information) regarding print functions realizable by the multifunction peripheral 30 (Step S330).

The PSA analyzes the print function information acquired from the multifunction peripheral 30 (Step S340). The PSA determines, on the basis of the analysis result of the print function information, whether or not the multifunction peripheral 30 can support the print functions that can be realized by the multifunction peripheral 30 (Step S350).

In a case where it is determined that the function limitation is necessary (unsupportable) with respect to the print function which can be realized by the multifunction peripheral 30, the controller 11 determines the display in the UI in which the limitation is imposed on the corresponding print function (Step S350; Yes→Step S360). On the other hand, in a case where it is determined that the functional limitation is not necessary (supportable) with respect to the print functions which can be realized by the multifunction peripheral 30, the controller 11 determines the display in the UI without the functional limitation (Step S350; No→Step S370).

As described above, according to the Fourth Embodiment, it is configured such that the PSA determines whether to display the UI with the function limitation on the basis of the print function information obtained from the printing apparatus (multifunction peripheral) to cause the print to be performed and thus, the user can make optimum print setting in accordance with the printing apparatus by which the user desires print-out.

The present disclosure is not limited to the above-described Embodiments, and various modifications can be made. That is, the technical scope of the present disclosure also includes such embodiments that can be obtained by combining technical measures that are modified as appropriate within a range not departing from the gist of the present disclosure.

Further, although some parts of the above-described Embodiments were explained separately for convenience, it is a matter of course that the Embodiments may be executed in combination within a technically capable range.

Further, a program that operates on each apparatus in the Embodiments is a program that controls a CPU or the like (a program that causes a computer to function) so as to realize the functions of the above-described Embodiments. And the information handled in these apparatuses is temporarily accumulated in a temporary storage device (for example, the RAM) during processing and then, stored in various storage devices such as the ROM, HDD and the like, and is read, corrected, or written by the CPU as necessary.

Here, the computer-readable non-transitory recording medium in which the program is recorded in the information processing apparatus may be any of semiconductor media (for example, a ROM, a nonvolatile memory card, or the like), an optical recording medium/magneto-optical recording medium (for example, a Digital Versatile Disc (DVD), a Magneto Optical Disc (MO), a Mini Disc (MD), a Compact Disc (CD), a Blu-ray (Registered Trademark) disc (BD), or the like), a magnetic recording medium (for example, a magnetic tape, a flexible disk, or the like), or the like. In this case, the program recorded in the recording medium is read by the computer of the information processing apparatus and executed by the computer, whereby not only that the functions of the above-described Embodiments are realized, but also that the functions of the present disclosure are realized by executing processing in cooperation with an operating system, another application program, or the like on the basis of instructions of the program.

Further, in a case where the program is distributed in the market, the program can be stored in a portable recording medium and distributed, or can be transferred to a server computer connected via a network such as the Internet. In this case, a storage device of the server computer is also included in the present disclosure as a matter of course.

Further, each functional block or various features of the devices used in the above-described Embodiments can be implemented or executed by an electric circuit, for example, an integrated circuit or a plurality of integrated circuits. The electrical circuit that is designed to realize the functions described in the present specification may include a general-purpose processor, a digital signal processor (DSP), an application-specific integrated circuit (ASIC), a field programmable gate array (FPGA), other programmable logic devices, a discrete gate or transistor logic, a discrete hardware component, or a combination of them. The general-purpose processor may be a microprocessor or may be a conventional processor, a controller, a micro controller, or a state machine. The above-described electrical circuit may be configured as a digital circuit or may be configured as an analog circuit. Further, when an integrated circuit technology that replaces the current integrated circuits emerges as the result of progress of the semiconductor technology, one or more aspects of the present disclosure may also use new integrated circuits based on such technology.

What is claimed is:

1. An information processing apparatus comprising: a storage that stores an application capable of supporting print settings corresponding to a device in cooperation with a printer driver; a display that displays a user interface screen on the basis of the application; and
a controller that determines the printer driver associated with the application, wherein the controller
determines display contents of the user interface screen in accordance with the printer driver associated with the application.

2. The information processing apparatus according to claim 1, wherein the controller
determines to display the user interface screen with different display contents between when it is determined that the printer driver is an Internet Printing Protocol (IPP) class driver and when it is determined that the printer driver is a universal print class driver.

3. The information processing apparatus according to claim 2, wherein the display contents are
contents related to some of the print settings that are not supported by the universal print class driver.

4. The information processing apparatus according to claim 3, wherein some of the print settings not supported by the universal print class driver include a manuscript size, a sheet size, and a sheet type.

5. The information processing apparatus according to claim 2, wherein the controller
determines whether the printer driver associated with the application is the IPP class driver or the universal print class driver on a basis of a compatibility identifier obtained from device information managed by an Operating System.

6. The information processing apparatus according to claim 5, wherein the controller
determines, when the compatibility identifier could not be obtained, whether the printer driver associated with the application is the IPP class driver or the universal print class driver on the basis of a driver name obtained from the device information.

7. The information processing apparatus according to claim 1, wherein the controller
displays the printer driver associated with the application in an identifiable manner on the user interface screen.

8. The information processing apparatus according to claim 1, wherein the controller
determines the printer driver associated with the application by using selection of the device as a trigger each time a printing operation is started.

9. The information processing apparatus according to claim 1, wherein the controller
determines display contents of the user interface screen in accordance with the printer driver associated with the application at the time of activation of the application.

10. A display method comprising: storing an application capable of supporting print settings corresponding to a device in cooperation with a printer driver; displaying a user interface screen on the basis of the application; determining the printer driver associated with the application; and
determining display contents of the user interface screen in accordance with the printer driver associated with the application.

11. A non-transitory computer-readable recording medium having an application recorded thereon, wherein
the application cooperates with a printer driver and displays a user interface screen by an application capable of supporting print settings corresponding to a device; and
display contents of the user interface screen are determined in accordance with the associated printer driver.
